(19) United States
(12) Patent Application Publication
(10) Pub. No.: US 2005/0088375 A1
(43) Pub. Date: Apr. 28, 2005

(54) Plasma display panel and driving apparatus and method thereof

(76) Inventor: Jin-Boo Son, Suwon-si (KR)

Correspondence Address: CHRISTIE, PARKER & HALE, LLP, PO BOX 7068, PASADENA, CA, 91109-7068, US

(21) Appl. No.: 10/970,368

(22) Filed: Oct. 21, 2004

(30) Foreign Application Priority Data
Oct. 24, 2003 (KR) 10-2003-0074637

(51) Int. Cl. G09G 3/28

(52) U.S. Cl. 345/60

(57) ABSTRACT

A method for driving a PDP having a first electrode, a second electrode, and a panel capacitor formed therebetween. The method includes a reset period, an address period, and a sustain discharging period. In the reset period, a first voltage waveform falling from a first voltage to a second voltage is applied to the first electrode for a first period. Wall charges formed in the sustain discharging period are erased. A second voltage waveform rising from a third voltage to a fourth voltage is applied to the first electrode for a second period. A third voltage waveform falling from a fifth voltage to a sixth voltage which is lower than the second voltage is applied to the first electrode for a third period.

### CROSS REFERENCE TO RELATED APPLICATION

This application claims priority to and the benefit of Korea Patent Application No. 10-2003-0074637 filed on Oct. 24, 2003 in the Korean Intellectual Property Office, the entire content of which is incorporated herein by reference.

### BACKGROUND OF THE INVENTION

(a) Field of the Invention

The present invention relates to a plasma display panel (PDP) driving apparatus and method.

(b) Description of the Related Art

In addition to the PDP, various flat displays such as the liquid crystal display (LCD) and the field emission display (FED), have been developed. However, the PDP has higher resolution, a higher rate of emission efficiency, and an wider view angle in comparison with other flat panel displays. Accordingly, the PDP of large scale displays over 40 inches has been recognized as a substitute or successor for the conventional cathode ray tube (CRT).

The PDP is a flat panel display for showing characters or images using plasma generated by gas discharge, and includes more than hundreds of thousands to millions of pixels arranged in a matrix format, in which the number of pixels are determined by the size of the PDP. The PDP is generally categorized as either a DC PDP or an AC PDP according to applied driving voltage waveforms and the structure of its discharge cells.

Electrodes of the DC PDP are exposed in a discharge space, and current flows in the discharge space when a voltage is applied. It is therefore problematic to provide a resistor for current limitation.

On the other hand, electrodes of the AC PDP are covered with a dielectric layer, and the current is limited because of natural formation of capacitance components. The AC PDP electrodes are thereby protected from an ion impulse when discharging, and therefore, the life span of the AC PDP is typically longer than that of the DC PDP.

FIG. 1 shows a partial perspective view of the AC PDP. Scan electrodes 4 and sustain electrodes 5 in pairs are formed in parallel on first glass substrate 1, and are covered with dielectric layer 2 and protection film 3. A plurality of address electrodes 8 is established on second glass substrate 6, and address electrodes 8 are covered with insulator layer 7. Barrier ribs 9 are formed in parallel with address electrode 8 on insulator layer 7 between address electrodes 8. Phosphors 10 are formed on the surface of insulator layer 7 and on both sides of barrier ribs 9. First and second glass substrates 1, 6 face each other with discharge space 11 between glass substrates 1, 6 so that scan electrodes 4 and sustain electrodes 5 may respectively cross address electrodes 8. Discharge space 11 between address electrode 8 and a crossing part of a pair of scan electrode 4 and sustain electrode 5 forms discharge cell 12.

FIG. 2 schematically shows an electrode arrangement of the PDP. As shown in FIG. 2, the electrodes of the PDP are in an m×n matrix format. Address electrodes A1 to Am are arranged in a column direction and n scan electrodes Y1 to Yn and sustain electrodes X1 to Xn are arranged in a row direction alternatively. The scan electrodes will be referred to as “Y electrodes” and the sustain electrodes referred to as “X electrodes” hereinafter. Discharge cell 12 in FIG. 2 corresponds to discharge cell 12 in FIG. 1.

FIG. 3 shows a conventional PDP driving waveform diagram. Each subfield includes a reset period, an address period, and a sustain period. In the reset period, wall charges of previous sustain-discharging are erased, and a wall charges are established so as to stably perform the next address discharging. In the address period, cells that are turned on and turned off are selected, and the wall charges are accumulated to the cells that are turned on (i.e., addressed cells). In the sustain period, a discharge for substantially displaying images on the addressed cells is performed.

Operations of the conventional PDP driving method in the reset period will now be described. As shown in FIG. 3, the reset period includes an erase period I, Y ramp rising period II, and Y ramp falling period III.

(1) Erase Period I

A falling ramp gradually falling from sustain discharging voltage Vs to a ground voltage is applied to the Y electrode while the X electrode is biased with predetermined potential voltage Vbias, and the wall charges formed in the previous sustain period are eliminated.

(2) Y Ramp Rising Period II

A ramp voltage gradually rising from voltage Vs to voltage Vset is applied to the Y electrode while the address electrode (A) and the sustain electrode (X) are maintained at 0V. A weak reset discharging is generated to the address electrode (A) and the sustain electrode (X) from the scan electrode (Y) in the discharge cells while the ramp voltage is rising. Accordingly, (−) wall charges are accumulated on the scan electrode (Y), and (+) charges are concurrently accumulated on the address electrode (A) and the sustain electrode (X).

(3) Y Ramp Falling Period III

A ramp voltage gradually falling from voltage Vs to the ground voltage is applied to the Y electrode while the X electrode is maintained at constant voltage Vbias. A weak reset discharging is generated in the discharge cells while the ramp voltage is falling. Y ramp falling period III is provided to gradually reduce the wall charges accumulated by the Y rising ramp, and therefore the reduced wall charges are controlled accurately and address discharging is performed well as the time of the falling ramp is increased (that is, when the slope is gentle). Therefore, the ramp falling period is typically established to be greater than 80 usec.

The ramp of erase period I for an erase operation is provided to erase the wall charges formed in the sustain discharging, and the erase waveform is applied to be shorter than the applied period of the falling ramp because of priming effects. Therefore, the period of erase waveform is typically established to be less than 80 usec.

Conventionally, a circuit for applying the erase period I ramp waveform and a circuit for applying the ramp falling period III waveform are used respectively because the slopes of the erase ramp period I waveform and the ramp falling period III waveform are established differently, and accordingly, cost of the circuits is increased.

### SUMMARY OF THE INVENTION

In accordance with the present invention a plasma display panel is provided with a low-cost circuit and a driving apparatus thereof.

In one aspect of the present invention, a method for driving a plasma display panel having a first electrode, a second electrode, and a panel capacitor formed between the first electrode and the second electrode, includes: in a reset period, (a) applying a first voltage waveform falling from a first voltage to a second voltage to a first electrode, and erasing wall charges formed in previous sustain-discharging for a first period; (b) applying a second voltage waveform rising from a third voltage to a fourth voltage to the first electrode for a second period; and (c) applying a third voltage waveform falling from a fifth voltage to a sixth voltage which is lower than the second voltage to the first electrode for a third period.

In another aspect of the present invention, a method for driving a plasma display panel having a scan electrode, a sustain electrode, and a panel capacitor formed between the scan electrode and the sustain electrode, includes:
in the reset period, (a) applying a first voltage waveform falling from a first voltage to a second voltage to the scan electrode, and erasing the wall charges formed in the sustain discharging period; (b) applying a second voltage waveform rising from a third voltage to a fourth voltage to the scan electrode, generating a weak reset discharging in discharge cells, and generating the wall charges; and (c) applying a third voltage waveform which falls from a fifth voltage to a sixth voltage and has a slope corresponding to the first voltage waveform to the scan electrode, and erasing the wall charges formed in the (b).

In another aspect of the present invention, an apparatus for a plasma display panel having a scan electrode, a sustain electrode, and a panel capacitor formed between the scan electrode and the sustain electrode, includes: a sustain discharging voltage waveform generator including a first and a second transistor coupled in series between a first voltage and a second voltage, a node of the first and second transistors being coupled to the scan electrode, and the sustain discharging voltage waveform generator applying one of the first and the second voltage to the scan electrode; and an erase waveform and ramp falling waveform generator including a third transistor coupled between the scan electrode and a third voltage, and applying an erase waveform falling from the first voltage to a fourth voltage which is higher than the third voltage and a ramp falling waveform falling from the first voltage to the fourth voltage to the scan electrode in response to a switching operation of the third transistor.

The plasma display panel according to a characteristics of the present invention includes: a plasma panel having a plurality of address electrodes arranged in the column direction, and scan electrodes and sustain electrodes arranged alternately in the row direction; and a scan driver for supplying a scan voltage and a sustain discharging voltage to the scan electrode. The scan driver, in the reset period, applies a first voltage waveform falling from a first voltage to a second voltage to the scan electrode and erases wall charges formed in a sustain discharging period; applies a second voltage waveform rising from a third voltage to a fourth voltage to the scan electrode, generates a weak reset discharging in discharge cells, generates wall charges; and applies a third voltage waveform falling from a fifth voltage to a sixth voltage to the scan electrode and having a slope corresponding to the first voltage waveform, and erases the wall charges formed by the second voltage waveform.

### BRIEF DESCRIPTION OF THE DRAWINGS

FIG. 1 shows a partial perspective view of a conventional AC plasma display panel.

FIG. 2 shows an electrode arrangement of a conventional AC plasma display panel.

FIG. 3 shows a conventional plasma display panel driving waveform diagram.

FIG. 4 shows a block diagram of a plasma display panel according to an exemplary embodiment of the present invention.

FIG. 5 shows a plasma display panel driving waveform diagram according to an exemplary embodiment of the present invention.

FIG. 6 shows a schematic diagram of a plasma display panel driving circuit according to an exemplary embodiment of the present invention.

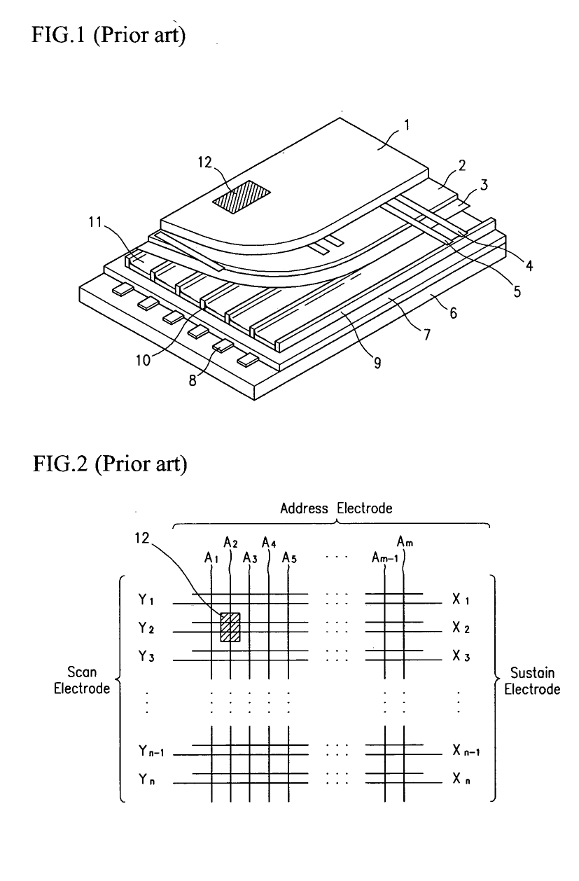

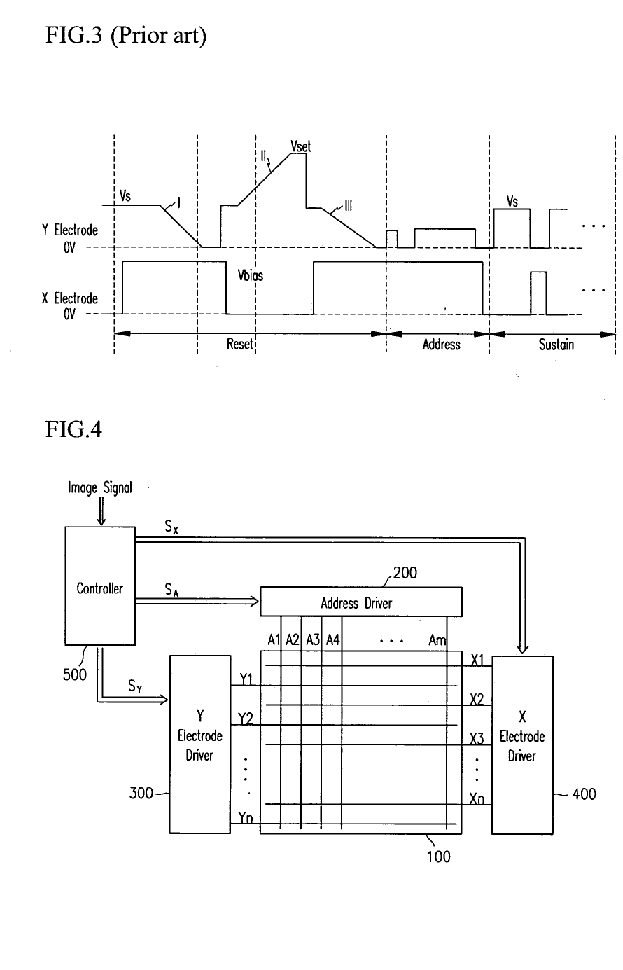

### DETAILED DESCRIPTION

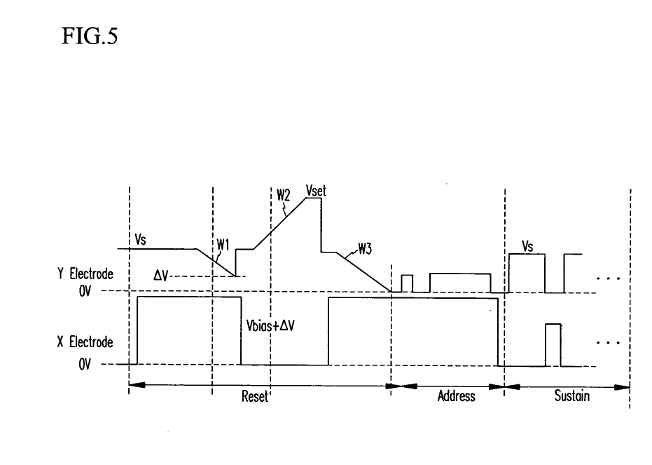

Referring to FIG. 4, the PDP according to an exemplary embodiment of the present invention includes plasma panel 100, address driver 200, Y electrode driver 300, X electrode driver 400, and controller 500.

Plasma panel 100 includes a plurality of address electrodes (A1-Am) arranged in a column direction, and scan electrodes (Y1-Yn) and sustain electrodes (X1-Xn) arranged alternately in a row direction.

Address driver 200 receives address driving control signal SA from controller 500 and applies a display data signal for selecting discharge cells to be displayed to each address electrode.

Y electrode driver 300 and X electrode driver 400 receive Y electrode driving signal S_{Y} and X electrode driving signal S_{X} from controller 500 respectively, and apply the same to the X electrode and the Y electrode.

Controller 500 receives an external image signal, generates address driving control signal S_{A}, Y electrode driving signal S_{Y}, and X electrode driving signal S_{X}, and transmits them to address driver 200, Y electrode driver 300, and X electrode driver 400, respectively.

Slopes of the erase waveform for erasure and a ramp falling waveform are established to correspond to each other according to the exemplary embodiment of the present invention. Therefore, circuit cost is reduced because the erase waveform and the ramp waveform are realized in one circuit.

It can be problematic that the reset period is increased because the slopes of the erase waveform and the ramp falling waveform are established correspondingly on the basis of the slope of the ramp falling. Therefore, although the slopes of the erase ramp waveform and the ramp falling waveform are established correspondingly, the lowest voltage of the erase waveform is established to be higher by ΔV than the lowest voltage of the ramp falling waveform. A bias voltage of the X electrode is increased as ΔV, and hence, an erase operation is performed in the exemplary embodiment of the present invention.

FIG. 5 shows a diagram of driving waveforms of the Y electrode driver 300 and X electrode driver 400 according to an exemplary embodiment of the present invention. As shown in FIG. 5, a reset period according to the exemplary embodiment of the present invention includes erase period W1, Y ramp rising period W2, and Y ramp falling period W3.

(1) Erase Period W1

A falling ramp gradually falling from sustain discharging voltage Vs to a voltage which is higher BY ΔV than a ground voltage is applied to the Y electrode while the X electrode is biased with predetermined potential voltage Vbias+ΔV, and the wall charges formed in the previous sustain period are erased.

(2) Y Ramp Rising Period W2

A ramp voltage gradually rising from voltage Vs to voltage Vset is applied to the Y electrode while the address electrode and the X electrode are maintained at 0V. A weak reset discharging is generated to the address electrode and the X electrode from the Y electrode in the discharge cells while the ramp voltage is rising. Accordingly, (−) wall charges are accumulated on the Y electrode, and (+) charges are accumulated on the address electrode and the X electrode (X).

(3) Y Ramp Falling Period W3

A ramp voltage gradually falling from voltage Vs to the ground voltage is applied to the Y electrode while the X electrode is biased with voltage Vbias+ΔV. A slope of the Y ramp falling period W3 waveform corresponds to the slope of the erase period W1 waveform. A weak reset discharging is generated in the discharge cells while the ramp voltage is falling.

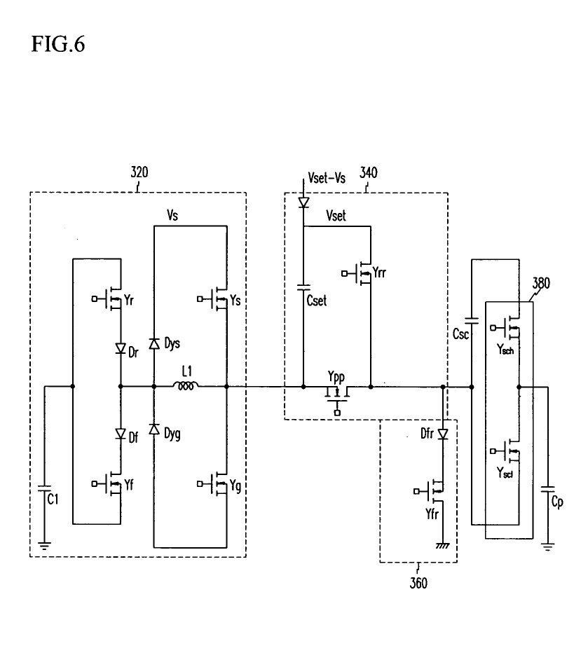

FIG. 6 shows a detailed circuit diagram of the Y electrode driver 300 according to the exemplary embodiment of the present invention. Y electrode driver 300 according to the exemplary embodiment of the present invention includes sustain discharging voltage waveform generator 320, Y ramp rising waveform generator 340, erase waveform and Y ramp falling waveform generator 360, and scan IC 380.

Sustain discharging waveform generator 320 includes transistors Yr, Yf, Ys, Yg, diodes Dr, Df, Ds, Dg, inductor L1, and capacitor C1. Transistors Ys, Yg are coupled in series between voltage Vs which is the sustain discharging voltage and the ground voltage, and are switches for providing the voltage of Vs and the ground voltage to panel capacitor Cp respectively. Capacitor C1, inductor L1, and transistors Yr, Yf form an energy recovery circuit, and charge a voltage of panel capacitor Cp with voltage Vs or discharge the same to the ground voltage.

Scan IC 380 includes a transistor Ysch and a transistor Yscl coupled to the scan electrode (a terminal of the panel capacitor), and sequentially provides the scan voltage to the scan electrode (Y electrode) of the plasma display panel.

Y ramp rising waveform generator 340 includes capacitor Cset, ramp rising transistor Yrr, and main path transistor Ypp, and applies a ramp rising voltage rising from voltage Vs to voltage Vset to panel capacitor Cp. Capacitor Cset is coupled to a node between the transistors Ys, Yg and a drain of transistor Yrr. Main path transistor Ypp is coupled between a node of transistors Ys, Yg and a source of transistor Yrr.

Erase waveform and Y ramp falling waveform generator 360 includes transistor Yfr and diode Dfr, and applies the erase period W1 waveform falling from voltage Vs to voltage ΔV and the ramp falling period W3 waveform falling from voltage Vs to the ground voltage to panel capacitor Cp.

According to the driving circuit of the exemplary embodiment of the present invention as shown in FIG. 6, circuit cost is reduced because the erase waveform and the Y ramp falling waveform are realized with the same circuit 360. In this instance, substantial heat may be generated to an FET element because the erase waveform and Y ramp falling waveform generator 360 is not operated with the field-effect transistor (FET) element fully opened. Therefore, it is desirable to reduce the temperature of the element by providing the circuit of erase waveform and Y ramp falling waveform generator 360 under a driving board for the purpose of better heat reduction.

The driving method according to the exemplary embodiment of the present invention will be described with reference to FIG. 5 and FIG. 6. First, capacitor Cset is assumed to be charged with voltage Vset-Vs, which is easily performed by turning on transistor Yg. Transistors Ypp, Yrr are turned off and transistor Yfr is turned on while sustain discharging voltage Vs is applied to the Y electrode. The erase period W1 waveform gradually falling from voltage Vs is applied to a first terminal (a Y electrode) of the panel capacitor. At this time, the erase waveform is to be the ramp falling waveform because transistor Yfr is a ramp switch by which a predetermined current flows between the source and the drain. Transistor Yfr is turned off and transistors Ys, Ypp are turned on when the voltage at the Y electrode reaches ΔV.

Transistor Ypp is turned off and transistor Yrr is turned on while transistor Y3 is turned on. Voltage Vs is supplied to a first terminal of capacitor C1, and a voltage at a second terminal of capacitor C1 becomes voltage Vset because capacitor C1 is pre-charged with voltage Vset-Vs. Voltage Vset at the second terminal of capacitor C1 is provided to Y electrode through transistor Yrr. Therefore, ramp rising waveform W2 is applied to the Y electrode.

Transistor Yrr is then turned off and transistor Yfr is turned on. The ramp falling period W3 waveform falling from voltage Vs to the ground potential is applied to the Y electrode.

As above described, circuit cost is reduced because the erase waveform and the ramp waveform are realized in one circuit according to the present invention.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

1. A method for driving a plasma display panel having a first electrode, a second electrode, and a panel capacitor formed between the first electrode and the second electrode, the method which includes a reset period, an address period, and a sustain discharging period, comprising:
in the reset period,
(a) applying a first voltage waveform falling from a first voltage to a second voltage to the first electrode for a first period, and erasing wall charges formed in the sustain discharging period;
(b) applying a second voltage waveform rising from a third voltage to a fourth voltage to the first electrode for a second period; and
(c) applying a third voltage waveform falling from a fifth voltage to a sixth voltage which is lower than the second voltage to the first electrode for a third period.

2. The method of claim 1, wherein the slopes of the first voltage waveform and the third voltage waveform are ramp falling waveforms.

3. The method of claim 2, wherein the slopes of the first voltage waveform and the third voltage waveform are established to correspond to each other.

4. The method of claim 1, wherein the first voltage is a sustain discharging voltage.

5. The method of claim 4, wherein the third voltage and the fifth voltage correspond to the first voltage.

6. The method of claim 1, wherein the fourth voltage is a ground voltage.

7. A method for driving a plasma display panel having a scan electrode, a sustain electrode, and a panel capacitor formed between the scan electrode and the sustain electrode, the method which includes a reset period, an address period, and a sustain period, comprising:
in the reset period,
(a) applying a first voltage waveform falling from a first voltage to a second voltage to the scan electrode and erasing the wall charges formed in the sustain discharging period;
(b) applying a second voltage waveform rising from a third voltage to a fourth voltage to the scan electrode, generating a weak reset discharging in discharge cells, and generating wall charges; and
(c) applying a third voltage waveform falling from a fifth voltage to a sixth voltage and having a slope corresponding to that of the first voltage waveform to the scan electrode, and erasing wall charges formed in (b).

8. The method of claim 7, wherein the second voltage is higher than the fourth voltage.

9. The method of claim 7, wherein the first voltage is a sustain discharging voltage.

10. The method of claim 9, wherein the third voltage and the fifth voltage correspond to the first voltage.

11. An apparatus for driving a plasma display panel comprising a scan electrode, a sustain electrode, and a panel capacitor formed between the scan electrode and the sustain electrode, comprising:
a sustain discharging voltage waveform generator including a first transistor and a second transistor coupled in series between a first voltage and a second voltage, a node of the first and second transistors being coupled to the scan electrode, and the sustain discharging voltage waveform generator applying one of the first and second voltages to the scan electrode; and
an erase waveform and ramp falling waveform generator including a third transistor coupled between the scan electrode and a third voltage, and applying an erase waveform falling from the first voltage to a fourth voltage which is higher than the third voltage and a ramp falling waveform falling from the first voltage to the fourth voltage to the scan electrode in response to a switching operation of the third transistor.

12. The driving apparatus of claim 11, further comprising a ramp rising waveform generator including: a first capacitor a terminal of which is coupled to a node between the first transistor and the second transistor; a fourth transistor coupled to a second terminal of the first capacitor; and a fifth transistor coupled to the scan electrode and a node of between the first transistor and the second transistor, and applying a ramp rising voltage rising from a fifth voltage to a sixth voltage to the scan electrode.

13. The apparatus of claim 12, wherein the slopes of the erase waveform and the ramp falling waveform are established to correspond to each other.

14. The apparatus of claim 11, wherein the first voltage is a sustain discharging voltage and the second voltage is a ground voltage.

15. The driving apparatus of claim 11, wherein the erase waveform and ramp falling waveform generator is arranged under a driving board.

16. A plasma display panel comprising:
a plasma panel having a plurality of address electrodes arranged in the column direction, and scan electrodes and sustain electrodes alternately arranged in the row direction; and
a scan driver for supplying a scan voltage and a sustain discharging voltage to the scan electrode,
wherein the scan driver, in the reset period,
applies a first voltage waveform falling from a first voltage to a second voltage to the scan electrode and erases wall charges formed in a sustain discharging period,
applies a second voltage waveform rising from a third voltage to a fourth voltage to the scan electrode, generates a weak reset discharging in discharge cells, and generates wall charges; and
applies a third voltage waveform falling from a fifth voltage to a sixth voltage to the scan electrode and having a slope corresponding to that of the first voltage waveform, and erases the wall charges formed by the second voltage waveform.

17. The plasma display panel of claim 16, wherein the second voltage is higher than the fourth voltage.

18. The driving method of the plasma display panel of claim 16, wherein the first voltage is a sustain discharging voltage.

19. The plasma display panel of claim 18, wherein the third voltage and the fifth voltage correspond to the first voltage.
